(19) United States
(12) Patent Application Publication
(10) Pub. No.: US 2023/0315942 A1
(43) Pub. Date: Oct. 5, 2023

(54) SOLAR PANEL INSTALLATION DESIGN PROGRAM

(71) Applicant: Logically Engineered Automation Features LTD, Stow, OH (US)

(72) Inventors: Evan Haug, Stow, OH (US); Benjamin Trabold, Columbus, OH (US); Jacob Prusky, Dallas, TX (US)

(73) Assignee: Logically Engineered Automation Features LTD, Stow, OH (US)

(21) Appl. No.: 18/130,723

(22) Filed: Apr. 4, 2023

Related U.S. Application Data
(60) Provisional application No. 63/362,443, filed on Apr. 4, 2022.

(51) Int. Cl. G06F 30/20; G06F 30/13

(52) U.S. Cl. CPC G06F 30/20; G06F 30/13; G06F 2113/04

(57) ABSTRACT

A process and computer program for designing solar array installations is provided. A user of the process or computer program provides a CAD file specifying a 2D photovoltaic (PV) array layout. Components and electrical properties of array components are specified. The 2D CAD file is converted to a 2D coordinate grid of cells where each cell is assigned a value indicate the presence or absence of a PV module. An ideal PV string length is calculated and permuted. Holes and edges of the array are identified and recorded. Strings are iteratively generated, in accordance with the ideal and permuted string lengths, and a stringing solution is passed to a CAD program.

This application claims the benefit of pending U.S. Provisional Patent Application No. 63/362,443 filed Apr. 4, 2022, which is hereby incorporated by reference in its entirety.

### I. BACKGROUND OF THE INVENTION

### A. Field of Invention

The invention relates to the field of solar panel system design, particularly, methods and systems for automated design of solar panel systems.

### B. Description of the Related Art

The solar industry is rapidly expanding in both popularity and demand, spurred by continuous advancement in the areas of solar efficiency and technology costs. However, the solar engineering industry has not yet fully adapted to support this rapid growth, relying on drafting—i.e., creating or drawing the symbols and schematics of a project in a CAD software—in which an engineer translates their design into a format that can be reviewed for permit and installation. Among the tasks an engineer must complete during drafting is stringing, or manually drawing out the wiring topology between photovoltaic (PV) panels (also referred to herein as photovoltaic modules and PV modules). Stringing follows strict guidelines as set forth by the National Electric Code which dictates the configuration and length of direct current (DC) strings according to design parameters including the electrical properties of the selected PV panels and DC/AC inverters, the quantities of this solar hardware, and a region-specific temperature coefficient. Ensuring that stringing designs are both NEC compliant and optimized for labor-efficient installation is extremely time consuming for an engineer, creating a bottleneck which serves as a limiting factor for how quickly a solar engineering firm can plan out a design. Presently, the most expensive part of solar installation is no longer the required hardware for the project, but rather the amount of labor it takes to bring the project to fruition. For this reason, installers have put a lot of effort toward investigating and implementing time-saving design and installation techniques that minimize the amount of expensive journeyman electrician hours needed to install a complete solar array. What is currently missing in the market is an autonomous computer-implemented method of optimizing the wiring design of solar panels in an array that minimizes labor costs, while producing an electrical code-compliant design.

Some embodiments of the present invention may provide one or more benefits or advantages over the prior art.

### II. SUMMARY OF THE INVENTION

Some embodiments may relate to method of designing solar array installation, computer programs for designing such installations, and methods of configuring such installations. For instance, embodiments may include a step of providing a CAD file, in digital or hardcopy form, specifying a two-dimensional photovoltaic module array layout. A designer may separately key in hardware quantities and their electrical properties, or a computer may be configured to automatically recognize this data in a scan of a hardcopy CAD file. The data may include components of the two-dimensional photovoltaic module array layout, including a quantity of photovoltaic modules comprising the specified array, a quantity of inverters comprising the specified array, a quantity of MPPTs per inverter, a rated MPPT voltage; a rated MPPT amperage, a rated voltage of the photovoltaic modules at maximum power, a maximum DC input voltage of each of the quantity of inverters, a rated open circuit voltage of the photovoltaic modules, an expected operating temperature range, and a regional temperature constant. Embodiments may convert the CAD file to a two-dimensional coordinate grid of cells, wherein each cell is assigned one of two values indicating either the presence or the absence of a photovoltaic module in accordance with the CAD file. Embodiments may calculate and record an ideal string length according to methods described herein. Embodiments may permute the ideal string length at least once, and record the at least one permuted ideal string length. Embodiments may identify hole cells in the specified array, and record coordinates of the identified hole cells. Embodiments may identify edge cells in the specified array, and record coordinates of the identified edge cells. Embodiments may generate a string linearly or heuristically beginning from a recorded coordinate of an edge cell in accordance with the ideal string length and the at least one permuted ideal string length. Embodiments may iterate the step of generating a string until all photovoltaic modules of the two-dimensional photovoltaic module array layout have been strung. Finally, embodiments may pass a valid stringing solution to a CAD program, wherein the valid stringing solution strings all photovoltaic modules of the two-dimensional photovoltaic module array.

Other benefits and advantages will become apparent to those skilled in the art to which it pertains upon reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof, wherein like reference numerals indicate like structure, and wherein:

FIG. 1 is a diagram illustrating the operation of a computer program of the invention;

FIG. 2 is a process diagram illustrating steps according to a method of the invention;

FIG. 3 is an illustration of a data input screen according to an embodiment;

FIG. 4 is an illustration of an array rendering typical of a CAD program;

FIG. 5 is a numerical matrix and coordinate grid representation of the array of FIG. 4;

FIG. 6 is an illustration of a hole according to embodiments of the invention;

FIG. 7 is an illustration of a von Neumann neighborhood;

FIG. 8 is an illustration of a 3×3 Moore neighborhood;

FIG. 9 is an illustration of a 5×5 Moore neighborhood;

FIG. 10 is an illustration of edges and non-edges according to embodiments of the invention;

FIG. 11 is an illustration of a linear stringing solution according to embodiments of the invention;

FIG. 12 is a numerical matrix and coordinate grid representation of the stringing solution of FIG. 11;

FIG. 13 is an illustration of an heuristic stringing solution according to embodiments of the invention;

FIG. 14 is a numerical matrix and coordinate grid representation of the stringing solution of FIG. 13;

FIG. 15 is an illustration of an heuristic stringing solution according to embodiments of the invention; and

FIG. 16 is a numerical coordinate matrix of a rectangular stringing solution illustrated of 405 panels having no holes or vacant cells.

### IV. DETAILED DESCRIPTION OF THE INVENTION

As used herein the terms “embodiment”, “embodiments”, “some embodiments”, “other embodiments” and so on are not exclusive of one another. Except where there is an explicit statement to the contrary, all descriptions of the features and elements of the various embodiments disclosed herein may be combined in all operable combinations thereof.

Language used herein to describe process steps may include words such as “then” which suggest an order of operations; however, one skilled in the art will appreciate that the use of such terms is often a matter of convenience and does not necessarily limit the process being described to a particular order of steps.

Conjunctions and combinations of conjunctions (e.g. “and/or”) are used herein when reciting elements and characteristics of embodiments; however, unless specifically stated to the contrary or required by context, “and”, “or” and “and/or” are interchangeable and do not necessarily require every element of a list or only one element of a list to the exclusion of others.

Terms of degree, terms of approximation, and/or subjective terms may be used herein to describe certain features or elements of the invention. In each case sufficient disclosure is provided to inform the person having ordinary skill in the art in accordance with the written description requirement and the definiteness requirement of 35 U.S.C. 112.

As used herein azimuth means the horizontal angle of a panel's face relative to the southern point of the horizon. Accordingly, due south is 0°, due east is −90°, due west is 90°, and due north is 180°.

As used herein the term record, recorded, or recording means electronically storing a datum or data in volatile or non-volatile computer media, for any purpose, including but not limited to, recall for use by a computer program.

Turning to the substance of the invention, one of the most effective applications of labor-optimization methods, according to some embodiments of the invention, is minimizing the number of instances where an installer must travel between rows of an array anywhere but the extents, or edges, of the rows to run wiring. This is also referred to herein as “inter-row stringing”. In order to optimize the stringing configuration of an array, panels in the same row are interlocked horizontally across the entire row, serving as a physical barrier preventing anyone from walking between rows anywhere except for the ends of the rows. Each time the stringing diagram of an array specifies that the wiring must travel between rows in the middle of an array, the electrician must route his current string toward the next row, walk all the way to the end of the row, into the next one and walk back to where the stringing was terminated in the previous row. Collectively, multiple instances of inter-row stringing over the course of a large project can greatly increase the installation time by thousands of dollars in extra labor.

According to some embodiments of the invention, an optimization process includes several calculable quantities. A first group of such quantities relate to safety and compliance with National Electrical Code (NEC) standards. For instance, and without limitation, such quantities include the rated maximum power point tracker (MPPT) voltage in the inverter (V_{dc,min}), the rated voltage of the panels (Vₘₚ) at maximum power, the maximum DC input voltage (V_{dc,max}), and the open-circuit voltage of the panels (V_{oc}). These known values enable calculation of the minimum and maximum number of panels that can be strung together (Pₘᵢₙ and Pₘₐₓ) according to equations 1 and 2.

$${P}_{min} = \frac{{V}_{dc , min}}{{V}_{mp}} \qquad Eq . 1$$

$${P}_{max} = \frac{{V}_{dc , max}}{{V}_{oc}} \qquad Eq . 2$$

The expected maximum DC voltage input (V_{dc,max}) must be calculated to ensure the inverter will not be damaged on an especially cold day. Counterintuitively, solar arrays generate their highest power on cold days where the conductivity of all electrical components in the array are at their very highest. For this reason, the effect of the minimum expected temperature over the course of a year must be calculated. A regional temperature coefficient is used to ensure the safety of the array design based on local climate statistics. Similarly, the expected minimum DC voltage (V_{dc,min}) must also be calculated to ensure that the system will never drop below the minimum voltage necessary to operate. Conductivity drops as temperature increases; therefore, on very hot days, the system is at risk of not reaching this minimum voltage threshold (V_{dc,min}), preventing it from operating.

A second group of quantities shown in Equations 3 and 4 are used to determine the expected range of output voltages of the strings of panels, which also serve as the input voltages of the inverter, where V_{dc,min} and V_{dc,max} are the minimum and maximum rated inverter input voltages, Pₙ is the number of panels per string, T_{c} is the universal temperature coefficient, and Tₘᵢₙ and Tₘₐₓ are the minimum and maximum expected regional temperatures. Embodiments validate design data inputted by a user to ensure that it satisfies equations 3 and 4.

V_{dc,min}≤Pₙ[V_{oc}−T_{c}V_{oc}(25° C.−Tₘᵢₙ)] Eq. 3

V_{dc,max}≥Pₙ[V_{oc}−T_{c}V_{oc}(25° C.−Tₘₐₓ)] Eq. 4

Additionally, embodiments include a safety buffer to allow for current fluctuations. For example, Eq. 5 includes a 25% buffer between actual and rated currents as required by the standards promulgated by the National Fire Protection Association (NFPA). According to Eq. 5, I_{sc,inv} is the rated short circuit current of the inverter, I_{sc,p} is the rated short circuit current of the panels, and Mₙ is the number of strings that can be collected by a single MPPT, also referred to herein as the number of slots per MPPT. If this condition is not satisfied, the inverter is at risk of being overpowered, resulting in a short circuit and failure. Embodiments may include a feature for indicating to the user that a design does not satisfy Eq. 5. For instance, embodiments may provide the user with a pop-up window to alert the user to a possible over-power condition. The user can then review their calculations, coefficients, and local adoption of the NFPA code to ensure that the system meets these requirements and will pass inspection. The user may wish to exercise their engineering discretion and continue with the design despite the warning.

I_{sc,inv}≥(1.25)I_{sc,p}Mₙ Eq. 5

Equations 1 through 5 represent certain tests for electrically sound design parameters. Equations 1 through 4 define a safe range of the number of panels in an array based on inverter, MPPT, and solar panel hardware selections made by the user, and based on environmental variables, namely regional temperature statistics. Equation 5 defines a safe operating current for the inverter (I_{sc,inv}). Embodiments use Equations 1-5 to test user inputs pre-optimization to ensure that the inputs are electrically sound. Embodiments use Equation 1-5 again on each candidate solution, post-optimization, to eliminate any candidates that may be unsound. For instance, the cellular automata (CA) methods described herein for generating strings could potentially arrange components in a way that violates one or more of Equations 1-5. Testing each candidate solution ensure that all candidates meet code requirements.

Embodiments of the invention include computer programs such as, without limitation, plugin programs executable within well-known computer aided design (CAD) environments like AutoCAD. The invention is not limited to particular programming languages, and the person having ordinary skill in the art is readily capable of selecting an appropriate language and/or development environment in which to code embodiments. One suitable language and development environment is C# and the .NET framework. For instance, some embodiments can include a first module handling electrical information such as hardware parameters, a second module handling stringing solutions, and a third module extracting data from CAD drawings for converting them to coordinate matrices.

The person having ordinary skill in the art will understand that the invention is not limited to this particular allocation of functions to a first, second, and third module, and that functionality may be divided between modules in any convenient way or may even be contained in a single module. For example in other embodiments, a module that extracts data from digital CAD drawings for converting the CAD drawing to a coordinate matrix (a two-dimensional photovoltaic module array layout) may also extract hardware specifications and electrical properties from the digital CAD file, rather than requiring the user to input them manually. In another embodiment, a computer program according to the invention may provide functionality for scanning a hardcopy of a CAD file to a digital form, and automatically recognizing and recording the hardware features and wiring specified by the hardcopy drawing. As used here, the term “automatically recognizing” means recognition by a suitably programmed computer according to means and methodology well-known to the ordinarily skilled artisan. In such embodiments, the hardcopy CAD drawing may specify a two-dimensional photovoltaic module array layout, which the embodiment converts to a digital CAD file specifying a two-dimensional photovoltaic module array layout. Embodiments include a graphical user interface (GUI) handling all interfacing between the software and the user.

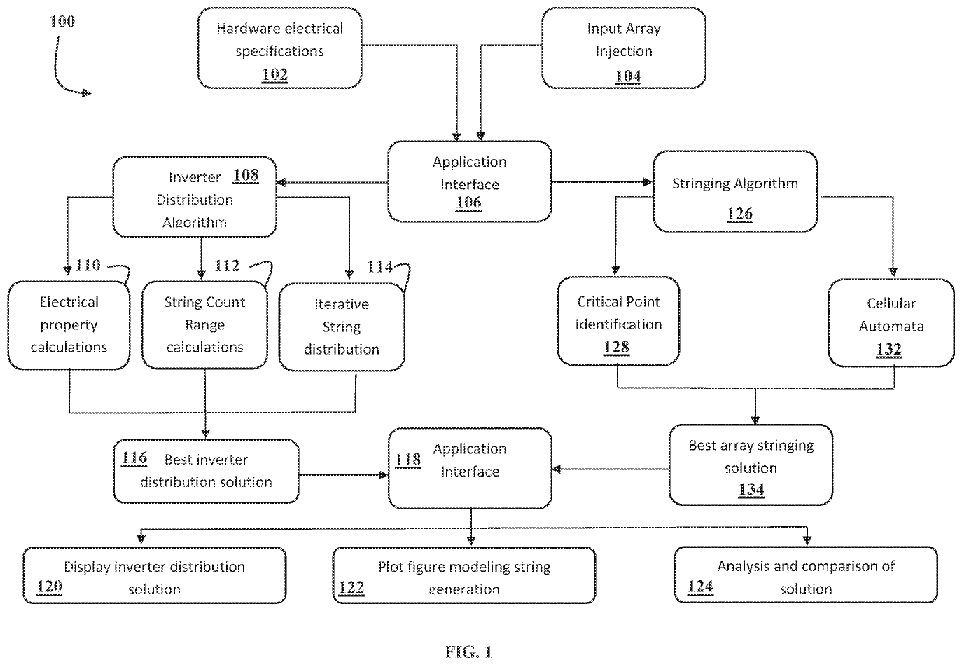

FIG. 1 illustrates the architecture of one such software embodiment 100. An application interface (GUI) receives hardware specifications 102 and an input array 104 from a user. The software 100 then executes an inverter distribution algorithm 108 on the user inputs. As part of the algorithm 108, in step 110 the software applies Equations 3 through 5 to the inputs to establish that the specification's electrical properties meet safety and electrical code requirements. Similarly, in step 112, the embodiment 100 calculates an allowed range of PV string lengths (Pₘᵢₙ and Pₘₐₓ), corresponding to Equations 1 and 2. In step 114, the embodiment iteratively determines an optimum configuration for connecting strings to inverters, resulting in an optimized inverter distribution 116.

With continuing reference to FIG. 1, the embodiment 100 also executes a stringing algorithm 126 to find and score all possible stringing configurations. The software 100 converts the user-inputted array to a rectangular numerical grid of cells each assigned a value of either 0 or 1, where 1 indicates the presence of a PV panel, and 0 indicates a vacant cell. At 128, the software 100 identifies critical points, namely, edges, corners and holes, which will be discussed in more detail herein. The holes are areas that cannot be strung because they do not contain PV panels and have a full von Neumann neighborhood of cells containing PV panels. The edges are cells having a von Neumann neighborhood of less than three PV panels, where at least one vertical and one horizontal von Neumann neighbor is vacant, having no PV panel. As used herein, a corner is a species of edge. The cellular automata (CA) method 132 then begins stringing from a randomly selected edge of the array, applying a set of rules for entering or passing over cells, which will be described in more detail herein. The CA method 132 is thus used to generate a set of stringing solutions, representing all possible stringing solutions that satisfy the design constraints and the CA rules. Each member of the set of solutions is scored according to methods that will be described herein, the smallest numerical score representing the optimum stringing solution 134.

The optimum stringing solution 134 and the optimum inverter distribution 116 are passed back to the application interface, which uses this information to display a graphic illustrating the optimized inverter distribution 120 and the optimized stringing solution 122. The embodiment 100 further provides an analysis of the solutions in comparison to other solutions.

### Inverter Distribution Algorithm 108: Electrical Property Calculations 110

Processes according to embodiments of the invention may evaluate electrical hardware specifications inputted by the user (see 110 of FIG. 1). Mathematical validation tests, exemplified by Equations 3-5, are run on the user-inputted data to prevent a user from attempting to generate a potentially dangerous, or electrically unsound, solution. The validations are run again to validate the safety of designs generated according methods of the invention. If the validation tests exemplified by Equations 3 and 4, detect that a user's hardware specifications fail to satisfy NEC standards, an error message may be displayed informing the user that the design is unsafe and, according to some embodiments, the program may be aborted immediately. If the user's hardware specifications pass these validation tests, the test exemplified by Equation 5 is run on the same hardware specification to detect overcurrent risk. According to some embodiments of the invention, the test results are displayed but the program does not abort. In such embodiments, the user can continue with design processes of the invention despite a possible overcurrent condition.

It may be advantageous not to abort the program for failing the test of Equation 5 because this standard has not been uniformly adopted. Some jurisdictions may specify a different current buffer (other than 25%) while others may specify none at all. For that reason, it may be advantageous to merely warn the user of an overcurrent risk. Alternatively, embodiments may allow the user to set the current buffer specified by local codes. Another alternative is that embodiments may be pre-programmed with electrical and fire codes from multiple jurisdictions, and may even be updated periodically. According to such embodiments, the user may be stopped, rather than merely warned.

### Inverter Distribution Algorithm 108: String Count Range Algorithm 112

After successfully completing the validation tests an embodiment executes a String Count Range Algorithm 112, which calculates a range of electrically-safe PV panel counts per string. Some string counts may not be suitable for a given design application, but others may be selected downstream by application of other algorithm steps. The Pₘₐₓ, Pₘᵢₙ range is defined by Equations 1 and 2, and depends on the outcome of the preceding electrical property calculations. According to some embodiments, the range can be divided into three sub-ranges signifying three separate stringing lengths between the maximum and minimum string count. According to other embodiments, rather than sub-ranges, three discrete string counts may be defined, namely, an optimum (Pₙ), optimum minus one (Pₙ₋₁), and optimum minus two (Pₙ₋₂). According to some embodiments, the three subranges or the three discrete string counts, are written to a first list and used later in the iterative string distribution algorithm to identify efficient designs, as explained more fully in the next section.

### Inverter Distribution Algorithm 108: Iterative String Distribution 114

An iterative string distribution algorithm 114 randomly selects sequentially generated strings from the first list many times to identify an optimized solution for connecting strings to inverters. According to some embodiments, the criterion being optimized is the power output of the inverter. Embodiments provisionally integrate randomly sampled strings into a theoretical design, and calculate the effect of the string on inverter power output. If the design has a higher power output than the most efficient design thus far it is recorded, overwriting the previously most efficient design. In projects requiring only a single string length, without resulting in unintegrated panels, an optimum is found quickly. However, for more complicated arrays that demand a collection of differently sized strings, embodiments may continue to cycle until a specified number of iterations occurs. Upon completion, embodiments may graphically display the optimal string/inverter distribution solution. For example, Tables I and II illustrate such a display.

The following example data, shown in Tables I and II, illustrates the electrical characteristics of a set of example strings according to the electrical specifications of selected solar PV modules and other hardware choices. Table I contains data corresponding to an optimal string/inverter distribution solution identified by the Iterative String Distribution algorithm 114. The Input column indicates each of three strings 1 through 3. Other data in rows 1-3 are electrical properties of the corresponding string. For instance, the String Tag column identifies individual strings. Embodiments may optionally include the following nomenclature in the format +A/BC, where “+” indicates the positive terminal of the string; “A” indicates a serially assigned string number; “/” separates the string number from other indicia; “B” indicates the inverter number that the string connects to; and “C” indicates the MPPT letter that the string connects to inside the indicated inverter. The Mod No. column indicates the number of PV modules in the corresponding string. The Power column indicates the power output of the string. The MV_{oc} indicates the maximum open circuit voltage (as modified by the regional temperature coefficient). The V_{oc} column indicates the open circuit voltage at standard operating temperatures and conditions i.e., Standard Test Conditions (STC). The V_{MP} column indicates voltage at maximum power. The I_{MP} column indicates current at maximum power. And, the I_{sc} column indicates the short circuit current.

TABLE I
String Data of an Optimized Stringing Solution
String Data

| | String | Mod | | | | | | |
|---|---|---|---|---|---|---|---|---|
| Input | Tag | No. | Power | MV_{OC} | V_{OC} | V_{MP} | I_{MP} | I_{SC} |
| 1 | 13/6a | 15 | 5925 | 846.5 | 742.5 | 621.0 | 9.6 | 10.2 |
| 2 | 14/6a | 15 | 5925 | 846.5 | 742.5 | 621.0 | 9.6 | 10.2 |
| 3 | 15/6a | 15 | 5925 | 846.5 | 742.5 | 621.0 | 9.6 | 10.2 |

Continuing with the example, the following Table II summarizes the electrical characteristics of each MPPT in an inverter according to the information from Table I and the electrical specifications of the inverter and the MPPT. The person having ordinary skill in the art will understand that different MPPTs and inverters can handle different amounts of voltage and current. Accordingly, embodiments optimize string length and the strings' connectivity to MPPTs to ensure the MPPT and inverter are operating in their optimal voltage and current ranges. In Table II, the Input column contains MPPT and inverter data corresponding to the optimal stringing solution identified by the Iterative String Distribution algorithm. Specifically, the input column indicates that the data all corresponds to a single MPPT, namely, MPPT1. The Power columns indicate the power output of the MPPT and inverter, receiving power from all three strings. The MV_{oc} indicates the maximum open circuit voltage (as modified by the regional temperature coefficient). The V_{MP} column indicates voltage at maximum power. The I_{MP} column indicates current at maximum power. And, the I_{sc} column indicates the short circuit current.

TABLE II
MPPT and Inverter Data of an Optimized Stringing Solution

| MPPT Data | | | | | | Inverter Data | | | | |
|---|---|---|---|---|---|---|---|---|---|---|
| Input | Power | MV_{OC} | V_{MP} | I_{MP} | I_{SC1.25} | Power | MV_{OC} | V_{MP} | I_{MP} | I_{SC1.25} |
| MPPT1 | 17775 | 846.5 | 621.0 | 28.7 | 38.4 | 1775 | 846.5 | 621 | 28.7 | 38.4 |

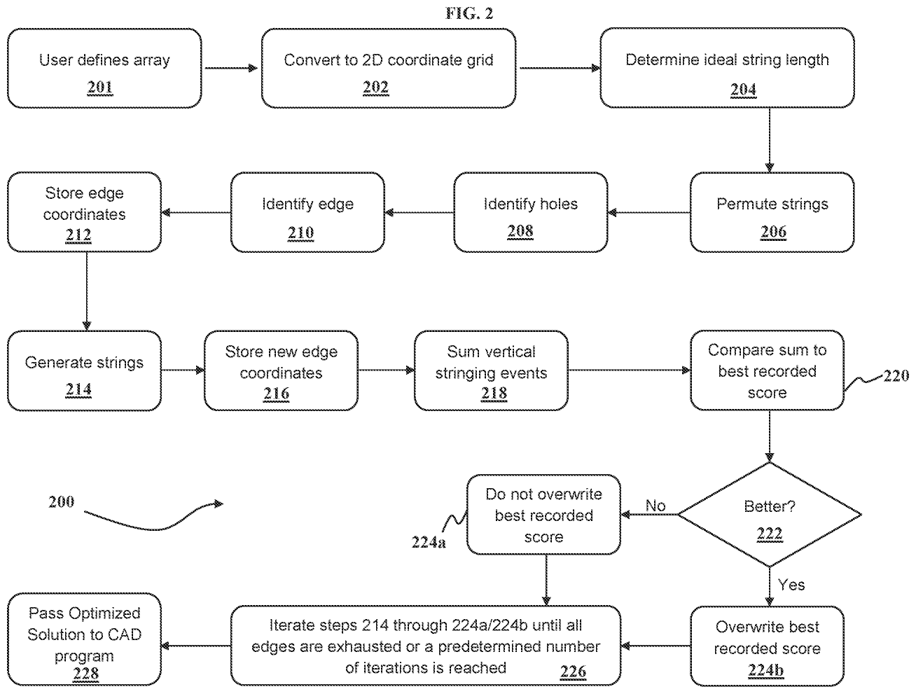

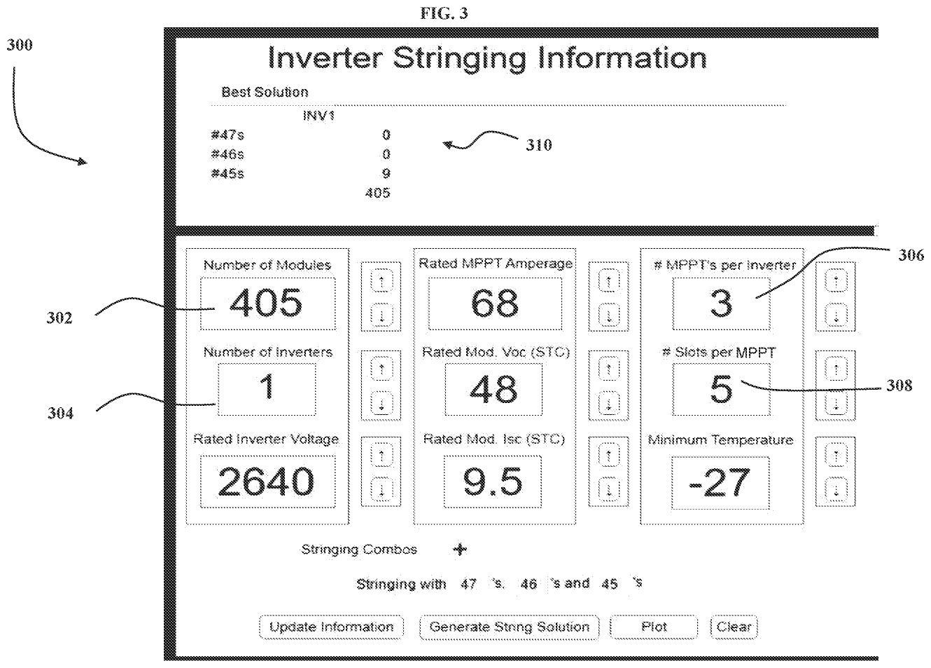

Turning to FIG. 2, illustrating process steps according to an embodiment 200 of the invention. In step 201 a user defines the array they wish to string. FIG. 3 is an illustration of an example input screen 300 according to one embodiment. With reference to FIG. 3, the user has inputted 405 PV panels in field 302, and indicated in fields 304 and 306 that the array will include one inverter having three MPPTs, each with five slots 308. Other fields include critical hardware ratings such as inverter voltage, MPPT amperage, module open circuit voltage (Mod. Voc) at STC, the modules' rated short circuit current, and the minimum expected temperature based on published climate statistics. The embodiment 200 applies Equations 1 through 5 to the user's inputs to validate the data in terms of its compliance with safety codes (see e.g. FIG. 1 at 110), and also determine the range of allowed string lengths Pₘᵢₙ, Pₘₐₓ (see e.g. FIG. 1 at 112).

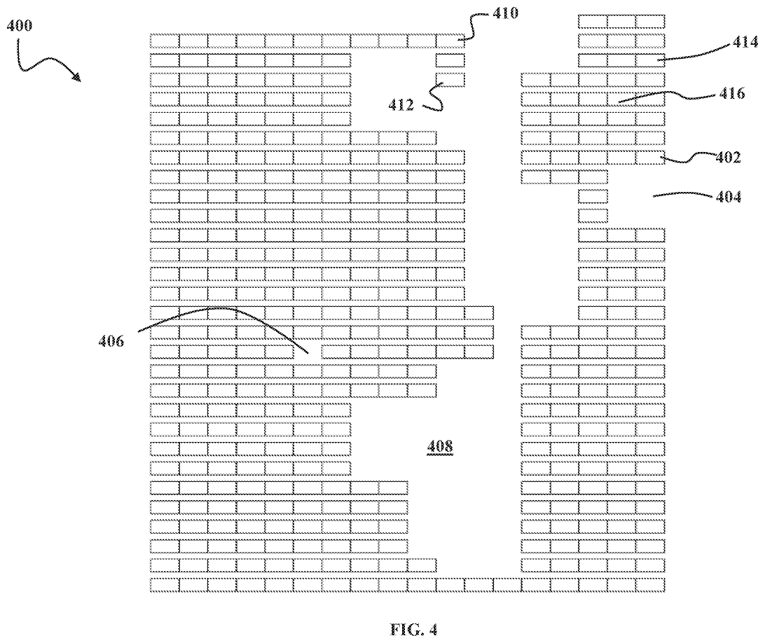

With reference to FIG. 4, the user has drawn a rectangular array 400 that it wishes to string. The array is represented as a set of boxes, or “cells”, 402 indicating the presence of a PV module. This drawing of array 400 is typical of a CAD program such as AutoCAD. The array 400 has negative space 408 where no PV module is present. This space can also be divided into cells e.g., 404. When the array's empty space 408 is considered, certain patterns emerge that become important for optimization. For instance a hole 406 has no PV module, but is surrounded by PV modules; a hole has a full Moore neighborhood. A corner, which is a species of “edge”, is illustrated at 410, having a von Neumann neighborhood of two PV modules below and to the left, but no other von Neumann neighbors. Another kind of extreme is noted at 412, where a PV module has only a single von Neumann neighbor. As discussed in more detail below, stringing operations begin at loci like this, but not at loci having three or more von Neumann neighbors like 414 or 416.

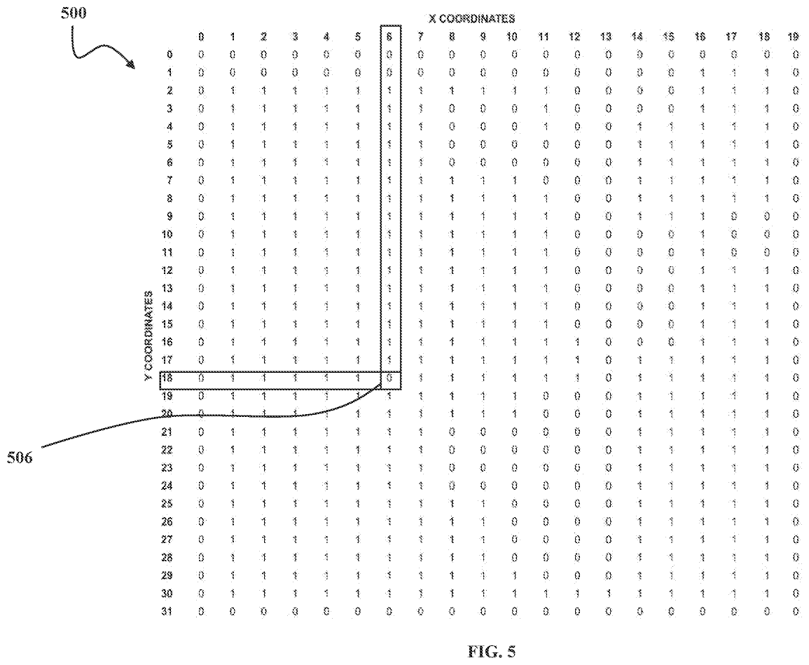

With reference to FIG. 2 at 202 and to FIG. 5, the software 200 converts the cells of the array 400 into a 2D coordinate grid 500 of states 1 and 0, where 1's correspond to cells having panels and 0's correspond to cells having no panels i.e., empty space. This numerical representation enables computational operations on the array leading to an optimized configuration. FIG. 2 at 204 indicates that the embodiment 200 next identifies an ideal string length, using the Iterative String Distribution algorithm (see also FIG. 1 at 114). As used herein, the term ideal string length is the maximum number of panels that can be strung without causing an over-power condition. Accordingly, Equation 2 for Pₘₐₓ is a calculation of the ideal string length. In view of the array topology and the hardware specifications inputted by the user, and in view of Equations 1 through 5, the embodiment can determine a combination of string lengths to use in generating stringing solutions. According to some embodiments, the string lengths are Pₙ, Pₙ₋₁ and Pₙ₋₂, where Pₙ is the ideal string length, Pₙ₋₁ is one less than the ideal string length, and Pₙ₋₂ is two less than the ideal length. Provided Pₙ₋₁ and Pₙ₋₂ are greater or equal to the minimum string length calculated in Equation 1, they can be used to generate stringing solutions. The person having ordinary skill in the art will understand that Pₙ₋₁ and Pₙ₋₂ are helpful but not required for producing stringing solutions. The n, n−1, n−2 pattern enriches the chances of generating valid solutions i.e., solutions having no left over PV units; however, if Pₙ₋₁ and/or Pₙ₋₂ are less than Pₘᵢₙ they can be omitted without departing from the scope of the invention. The embodiment 200 permutes string lengths Pₙ, Pₙ₋₁ and n Pₙ₋₂ to find combinations of string lengths with the available inverters and MPPTs that leave no unstrung panels. Alternatively, the embodiment lets the user know if no solution is possible. Instances where no solution is possible is referred to herein as a failure to produce a valid stringing solution. In FIG. 3, the optimal solution is shown at 310. In this example, the best solution is 9 strings all of which are at the ideal length (Pₙ) of 45 PV modules, and no strings have lengths Pₙ₋₁ or Pₙ₋₂. Accordingly, 405 panels can be strung in nine strings of 45 panels each, using the inputted hardware specifications and the provided array topology.

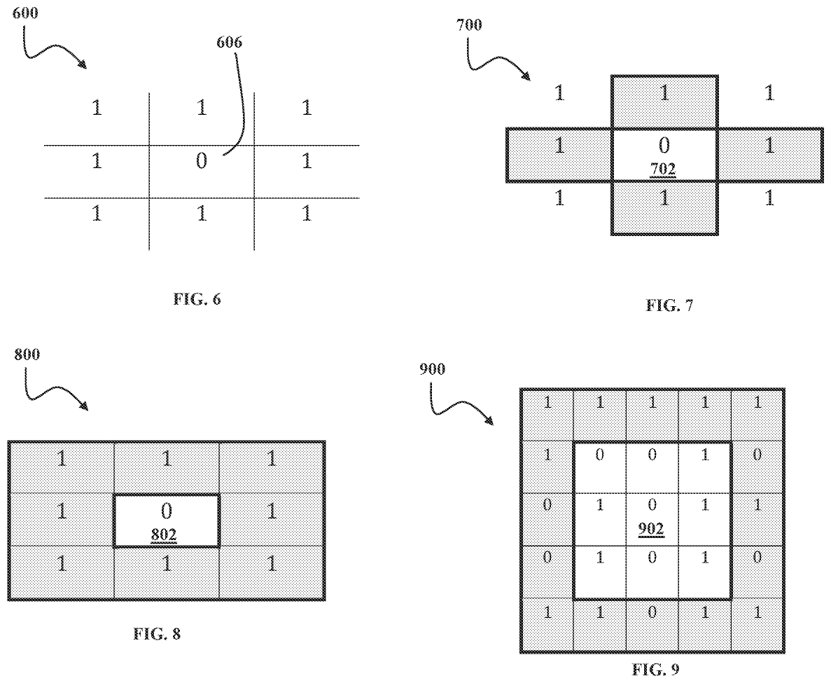

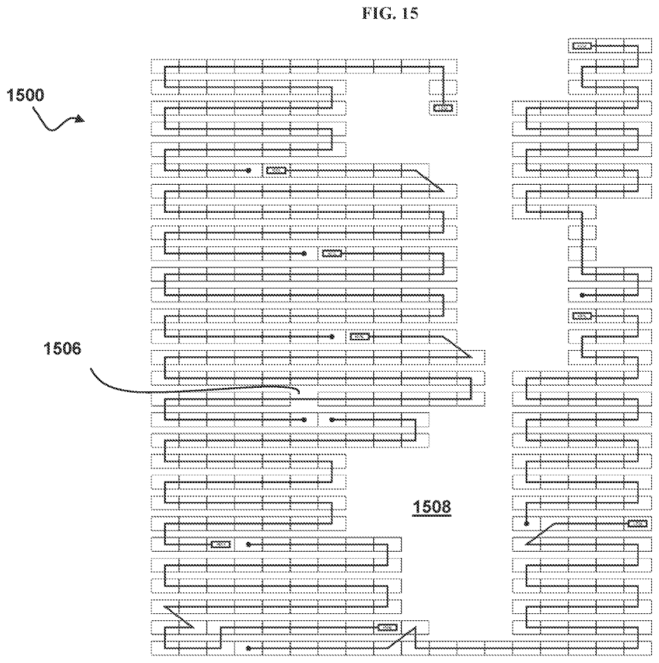

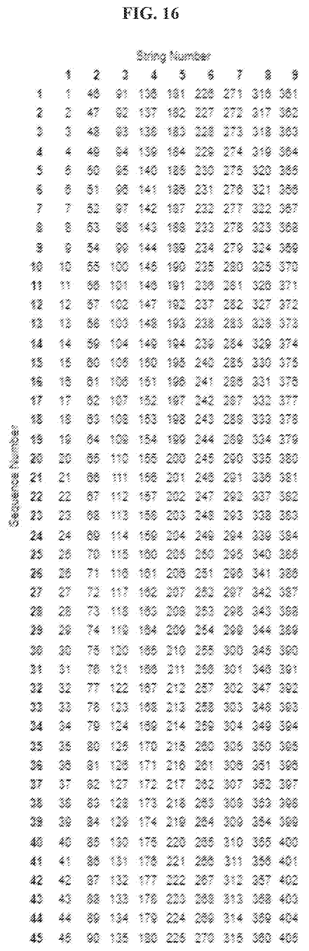

Moving on to 208 of FIG. 2, the embodiment 200 identifies all holes in the array where a hole is defined as a cell whose state is 0 and where all Moore neighborhood cell states are equal to one. An example of a hole can be found in the CAD drawing depicted in FIG. 4 at 406. The same hole can be seen in FIG. 5 at 506 in the form of a numerical coordinate grid. A generalization of a hole can be found in FIG. 6 at 606 (600 indicates the hole and its entire Moore neighborhood). As indicated in FIG. 5, the hole 506 is located at X-Y coordinate (6,18). The embodiment 200 records a list of the (X,Y) coordinate locations of all holes. As will be discussed in more detail, a cellular automata state transition function (Function 5) works in conjunction with the list of holes to jump over these single empty locations throughout the inside of the array while generating stringing solutions (see e.g. FIG. 15, element 1506). In contrast, embodiments string around larger void spaces, like 408 of FIG. 4, rather than through them (see e.g. element 1508 of FIG. 15).

With continuing reference to FIG. 2, at 210, the embodiment 200 next identifies edges, or extremes, of the array, which will serve as starting coordinates for stringing operations. As used here, an extreme or edge, is defined as a cell whose state is 1 and the sum of its surrounding von Neumann neighborhood cell states is less than 3, wherein at least one cell in the horizontal neighborhood and one cell in the vertical neighborhood are both equal to 0. FIG. 7 illustrates the von Neumann neighborhood 700 around a hole 702. The von Neumann neighbors are shown in gray, and consist of the cells to the left, right, top, and bottom of the central cell 702. Similarly, FIGS. 8 and 9 illustrate Moore neighborhoods. More specifically, the FIG. 8 depicts a 3×3 Moore neighborhood 800 in gray around a hole 802, and FIG. 9 illustrates a 5×5 Moore neighborhood in gray around a central cell 902 that is vacant but does not meet the definition of a hole.

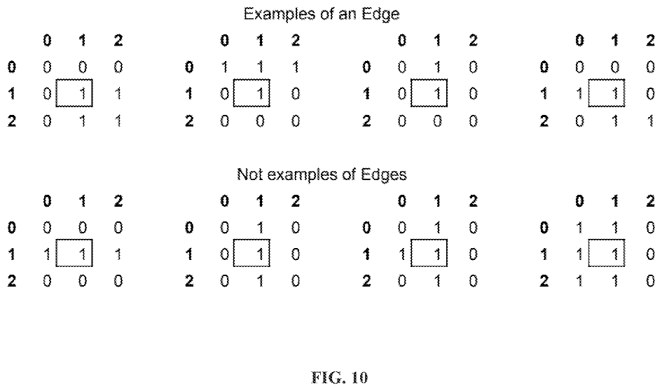

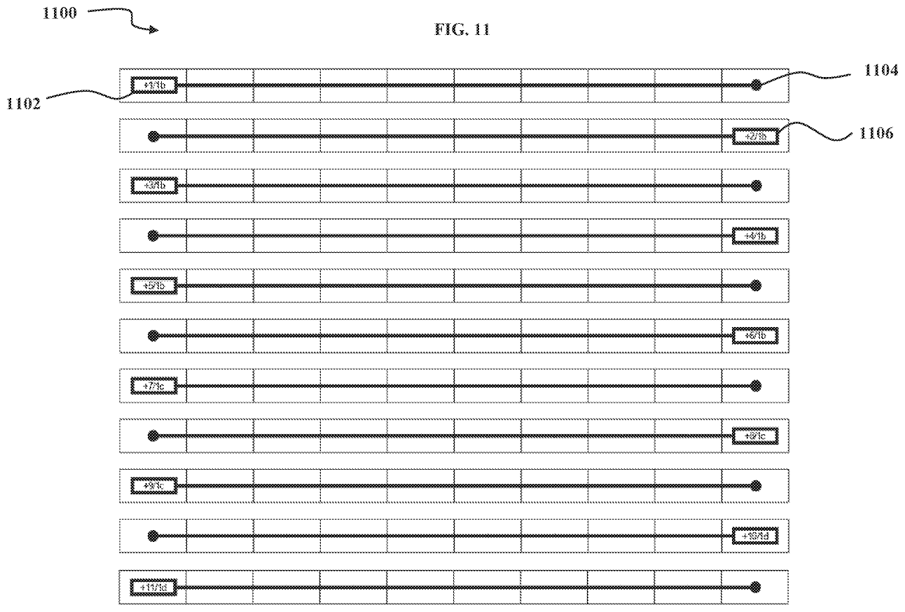

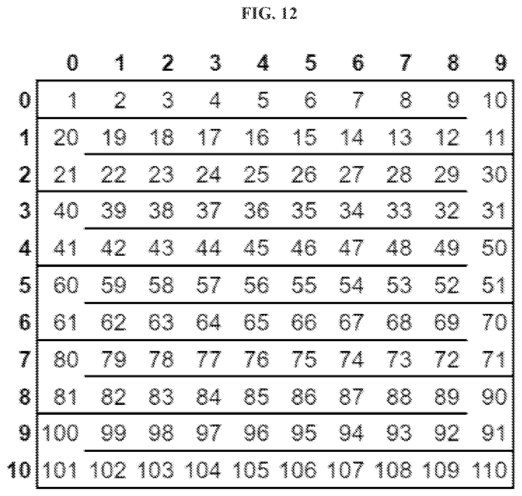

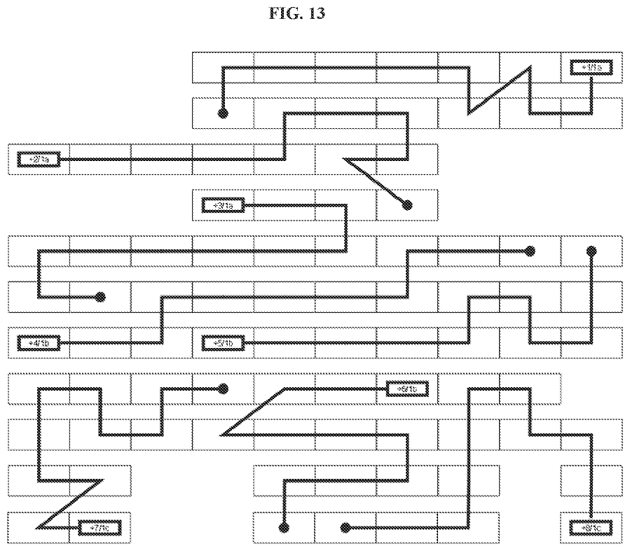

FIG. 10 illustrates several examples of edges, in coordinate grid form, as well as several examples of patterns that are not edges as defined herein. The embodiment 200 identifies all edges of the array 500 and records the X-Y coordinates of each edge in a list. The embodiment uses this list as location from which to begin stringing operations. The embodiment generates stringing solutions from this point by picking edge coordinates from the list, in no particular order, and designates that coordinate as the first cell of a string. The embodiment then applies logic to determine which cell to enter i.e., string to, next. The embodiment applies two different kinds of logic for this purpose. A first logic is to simply string linearly. FIG. 11 is an example of a linear stringing solution 1100. It consists of eleven rows of 10 PV units starting from an edge 1102 and ending at the last cell 1104 in the first row. The next string begins at 1106 where the first string ended, so that the string snakes through each PV unit in a straight path, advancing to the next row only at the end of the current row. FIG. 12 shows a numerical matrix representation of the stringing solution of FIG. 11. Stringing begins at (0,0) with “1” indicating the first PV unit in the array and 110 indicating the last PV unit in the array. These numbers are referred to herein as series values, indicating the position of a strung PV module in an array. While this is a simple solution, a linear string is not always possible in arrays having more complex topologies. Heuristic methods are better suited to complex topologies. Heuristic is a second type of stringing logic according to embodiments of the invention.

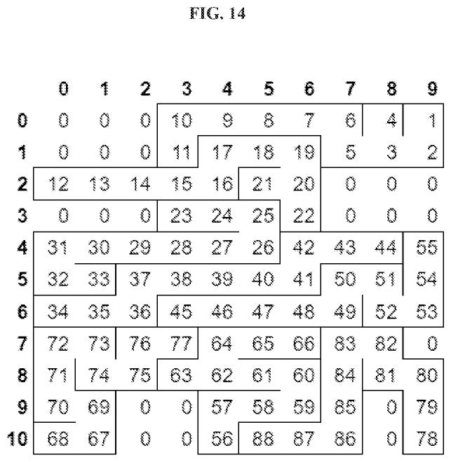

FIG. 13 is an example of a more complex array topology and a corresponding stringing solution found heuristically. FIG. 14 is a matrix representation of the same solution. Each string is generated (step 214 of FIG. 2) beginning from an edge of the array, which were stored in list form at 212 of FIG. 2. New edges are determined at the end of each iteration, and added to the list of edges (step 216 of FIG. 2). The new edge locations are used as new string starting points as the embodiment generates (step 214 of FIG. 2) new stringing solutions. This can result in designs where strings are scattered around the array. As edges are used to generate stringing solutions embodiments may ignore them in subsequent iterations to avoid generating duplicate solutions.

Both linear and heuristic stringing methods apply cellular automata to path-find through an array. Each cell in the matrix contains a state value of 0 if there is no PV module at that location, 1 if there is an unstrung PV module at that location, or a sequential value reflecting the PV module's position in the array, if it has been strung. Each of the cells in a stringing sequence according to embodiments of the invention (e.g. FIGS. 11 through 15) is entered and strung according to predetermined state transition functions. State transition functions provide the logical rules for selecting the next cell to enter and string from a plurality of neighbors. Linear state transition functions are relatively simple. They start from an edge, and simply string to the next cell in the row until the end of the row is reached. Then it strings to the first cell in the next row, continuing this process until reaching the last cell in the array. In contrast, heuristic state transition functions are equipped with more complex logic. Rather than simply entering the next cell in the row, a heuristic function of an embodiment prioritizes its von Neumann and/or Moore neighborhoods based on the state of each neighbor. An embodiment may run through a series of such heuristic functions in a predetermined order reflecting an order of priority among the transition functions. Tables III through VII are an example of state transition functions ordered according to priority of execution, where Table III is the highest, or first, priority and Table VII is the lowest, or last, priority. The logic outlined in each of Tables III through VII can be encoded according to known computer languages such as, but without limitation, C#. In some embodiments a set of heuristic state transition functions may include linear special cases that eliminate the need for separate linear state transition functions. In such embodiments, the same state transition functions are used to generate both linear and heuristic stringing solutions.

While the invention is not limited to the specific transition functions defined here, the following table provides an illustrative list of suitable functions. If an iteration does not enter any of the first four state transition functions, that iteration is discarded and a new iteration is started.

TABLE III
State Transition Function 1

State Transition Function 1:

| 1. | Criteria for entering | |
|---|---|---|
| | 1.1. | There are 3 neighbors in the von Neumann neighborhood whose states are equal to 1 |
| 2. | State determination priority (which cell location is next in sequence) | |
| | 2.1. | If the row above or below a cell has been strung according to the states of its Moore |
| | | neighborhood, it is prioritized |

State Transition Function 1:

| | 2.2. | Neighbors to the left and the right will be prioritized |
|---|---|---|
| | 2.3. | If a neighbor has two von Neumann neighbors with a state equal to 1, it is assigned the |
| | | highest priority |
| | 2.4. | If a neighbor has 1 von Neumann neighbor with a state equal to 1, it is assigned the |
| | | second highest priority. |
| 3. | Exiting state transition function | |
| | 3.1. | If there is a neighbor that has been prioritized: |

| | |
|---|---|
| 3.1.1. | That cell is set to be the next cell examined in the next iteration |
| 3.1.2. | The current cell's state is set to the next sequential stringing value |
| 3.1.3. | A Boolean is toggled, preventing state transition functions 2, 3 or 4 from triggering |
| | until the next cell is examined |

| | |
|---|---|
| 3.2. | If no neighbors meet the prioritization criteria: |

| | |
|---|---|
| 3.2.1. | Nothing happens, the state transition function is exited and the program continues |
| | on to the next state transition functions. |

TABLE IV
State Transition Function 2

State Transition Function 2:

| 1. | Criteria for entering | |
|---|---|---|
| | 1.1. | There are 2 neighbors in the von Neumann neighborhood whose states are equal to 1 |
| 2. | State determination priority (which cell location is next in sequence) | |
| | 2.1. | If a neighbor has two von Neumann neighbors with a state equal to 1, it is assigned the |
| | | highest priority |
| | 2.2. | If a neighbor has 1 von Neumann neighbor with a state equal to 1, it is assigned the |
| | | second highest priority. |
| 3. | Exiting state transition function | |
| | 3.1. | If there is a neighbor that has been prioritized: |

| | |
|---|---|
| 3.1.1. | That cell is set to be the next cell examined in the next iteration |

State Transition Function 2:

| | |
|---|---|
| 3.1.2. | The current cell's state is set to the next sequential stringing value |
| 3.1.3. | A Boolean is toggled, preventing state transition functions 1, 3 or 4 from triggering |
| | until the next cell is examined |

| | |
|---|---|
| 3.2. | If no neighbors meet the prioritization criteria: |

| | |
|---|---|
| 3.2.1. | Nothing happens, the state transition function is exited and the program continues |
| | on to the next state transition functions. |

TABLE V
State Transition Function 3

State Transition Function 3:

| 1. | Criteria for entering | |
|---|---|---|
| | 1.1. | There are 2 or 3 neighbors in the Moore neighborhood whose states are equal to 1 OR |
| | | the left and right neighbors are both not 1 |
| 2. | State determination priority (which cell location is next in sequence) | |
| | 2.1. | If a neighbor has two Von Neumann neighbors with a state equal to 1, it is assigned the |
| | | highest priority |
| | 2.2. | If a neighbor has 1 Von Neumann neighbor with a state equal to 1, it is assigned the |
| | | second highest priority. |
| 3. | Exiting state transition function | |
| | 3.1. | If there is a neighbor that has been prioritized: |

| | |
|---|---|
| 3.1.1. | That cell is set to be the next cell examined in the next iteration |
| 3.1.2. | The current cell's state is set to the next sequential stringing value |
| 3.1.3. | A Boolean is toggled, preventing state transition functions 1, 2 or 4 from triggering |
| | until the next cell is examined |

| | |
|---|---|
| 3.2. | If no neighbors meet the prioritization criteria: |

| | |
|---|---|
| 3.2.1. | Nothing happens, the state transition function is exited and the program continues |
| | on to the next state transition functions. |

TABLE VI
State Transition Function 4

State Transition Function 4:

| 1. | Criteria for entering | |
|---|---|---|
| | 1.1. | There is only 1 neighbor in the von Neumann neighborhood whose state is equal to 1 |
| 2. | State determination priority (which cell location is next in sequence) | |
| | 2.1. | There is only one choice in this case, that case is always chosen |
| 3. | Exiting state transition function | |
| | 3.1. | That cell is set to be the next cell examined in the next iteration |
| | 3.2. | The current cell's state is set to the next sequential stringing value |
| | 3.3. | No Boolean is toggled, there is not another state transition function that needs to be |
| | | prevented from entering |
| | 3.4. | If this function fails to string a cell, the solution is invalid. |

TABLE VII
State Transition Function 5

State Transition Function 5:

| 1. | Criteria for entering | |
|---|---|---|
| | 1.1. | Current cell coordinate location is found in the predetermined list of array hole |
| | | coordinates. |
| 2. | State determination priority (which cell location is next in sequence) | |
| | 2.1. | The direction of the cell from the previous state will be recorded and used to determine |
| | | the next cell to visit |
| 3. | Exiting state transition function | |
| | 3.1. | The next cell will be the cell determined by repeating the movement from the previous |
| | | state (The stringing pattern will keep moving in the direction it was moving) |

When a solution is completed, the number of vertical (row-to-row), and consecutive vertical, stringing events, comprising the solution, is counted and recorded (FIG. 2 at 218). This number represents an optimization score, where the smallest value indicates the optimum solution 226. As the program iterates through all of the potential solutions, every solution's optimization score is compared 222 to the previously saved best solution's optimization score and if it is less, the previous best solution will be overwritten 224b, otherwise the score may be discarded 224a. Alternatively, embodiments may store the less than optimum solution and/or score for later comparison or for use in analytics. After iterating through all extremes and both linear and heuristic methods, the embodiment 200 passes the optimum solution to the CAD software for conversion to linework, as shown in FIGS. 11, 13, and 15. The azimuth of the stringing lines will match exactly with the azimuth of the panels they are overlaying.

It will be apparent to those skilled in the art that the above methods and apparatuses may be changed or modified without departing from the general scope of the invention. The invention is intended to include all such modifications and alterations insofar as they come within the scope of the appended claims or the equivalents thereof.

Having thus described the invention, it is now claimed:

1. A process for designing solar array installations, comprising the steps of:
providing a CAD file specifying a two-dimensional photovoltaic module array layout;
specifying components of the two-dimensional photovoltaic module array layout, including a quantity of photovoltaic modules comprising the specified array, a quantity of inverters comprising the specified array, a quantity of MPPTs per inverter, a rated MPPT voltage; a rated MPPT amperage, a rated voltage of the photovoltaic modules at maximum power, a maximum DC input voltage of each of the quantity of inverters, a rated open circuit voltage of the photovoltaic modules, an expected operating temperature range, and a regional temperature constant;
converting the CAD file to a two-dimensional coordinate grid of cells, wherein each cell is assigned one of two values indicating either the presence or the absence of a photovoltaic module in accordance with the CAD file;
calculating and recording an ideal string length;
permuting the ideal string length at least once, and recording the at least one permuted ideal string length;
identifying hole cells in the specified array, and recording coordinates of the identified hole cells;
identifying edge cells in the specified array, and recording coordinates of the identified edge cells;
generating a string linearly or heuristically beginning from a recorded coordinate of an edge cell in accordance with the ideal string length and the at least one permuted ideal string length;
iterating the step of generating a string until all photovoltaic modules of the two-dimensional photovoltaic module array layout have been strung; and
passing a valid stringing solution to a CAD program, wherein the valid stringing solution strings all photovoltaic modules of the two-dimensional photovoltaic module array.

2. The process of claim 1, wherein the step of providing a CAD file is a step of providing a digital CAD file or a hardcopy of a CAD file.

3. The process of claim 1, wherein the step of specifying components is a step of manually keying in components of the two-dimensional photovoltaic module array layout, including a quantity of photovoltaic modules comprising the specified two-dimensional photovoltaic module array layout, a quantity of inverters comprising the specified two-dimensional photovoltaic module array layout, a quantity of MPPTs per inverter, a rated MPPT voltage; a rated MPPT amperage, a rated voltage of the photovoltaic modules at maximum power, a maximum DC input voltage of each of the quantity of inverters, a rated open circuit voltage of the photovoltaic modules, an expected operating temperature range, and a regional temperature constant; or
wherein the step of specifying components is a step of automatically recognizing, in the CAD file, components of the two-dimensional photovoltaic module array layout, including a quantity of photovoltaic modules comprising the specified two-dimensional photovoltaic module array layout, a quantity of inverters comprising the specified two-dimensional photovoltaic module array layout, a quantity of MPPTs per inverter, a rated MPPT voltage; a rated MPPT amperage, a rated voltage of the photovoltaic modules at maximum power, a maximum DC input voltage of each of the quantity of inverters, a rated open circuit voltage of the photovoltaic modules, an expected operating temperature range, and a regional temperature constant

4. The process of claim 1, further comprising the step of identifying new edge cells resulting from the step of generating strings, and recording the coordinates of the identified new edge cells;

5. The process of claim 1, further comprising the step of counting a number of vertical stringing events comprising a valid stringing solution.

6. The process of claim 5, further comprising the step of recording the number of vertical stringing events as an optimal stringing solution if the stringing solution is the first generated stringing solution, or comparing the number of vertical stringing events to a previously recorded optimal stringing solution and overwriting the previously recorded optimal stringing solution if the number of vertical stringing events is fewer than the previously recorded optimal stringing solution.

7. The process of claim 6, wherein the valid stringing solution passed to the CAD program is an optimal stringing solution.

8. The process of claim 1, wherein the step of specifying includes specifying a rated short circuit current of the inverter, a rated short circuit current of the photovoltaic modules, and a quantity of slots per MPPT.

9. The process of claim 1, wherein the step of permuting the ideal string length comprises the step of subtracting a value of 1 or 2 from the ideal string length.

10. The process of claim 1, wherein the step of generating strings further comprises the steps of:
selecting a first set of recorded coordinates corresponding to an identified edge cell;
assigning a series value of one to the first set of selected coordinates;
applying a state transition function to select a second set of coordinates corresponding to a second cell from a set of cells neighboring the edge cell;
selecting the second set of coordinates corresponding to the second cell; and
assigning a series value of two to the second set of coordinates.

11. The process of claim 10, further comprising the step of:
applying a state transition function to select a next set of coordinates corresponding to a cell from a set of cells neighboring a current cell;
selecting the next set of coordinates corresponding to the next cell from; and
assigning a series value of n+1 to the next set of coordinates, wherein n is a series value of a next-previous set of coordinates corresponding to a next-previous cell.

12. The process of claim 11, wherein the steps of applying, selecting, and assigning are iterated until either a valid stringing solution is generated or the process fails to produce a valid stringing solution.

13. The process of claim 1, further comprising the step of validating a stringing solution by determining whether the stringing solution would result in an over-power condition.

14. The process of claim 13, further comprising the step of testing a stringing solution by determining whether the solution includes a predetermined current buffer of between a rated current of a specified component of the two-dimensional photovoltaic module array and a maximum expected current.

15. The process of claim 14, wherein the predetermined buffer is a rated short circuit current of a specified inverter of the two-dimensional photovoltaic module array being at least 25% more than a maximum expected current.

16. The process of claim 15, wherein the process further comprises warning a user, and/or aborting the process, if the step of testing a stringing solution fails.

17. A computer program comprising program code instruction which, when executed by a processor of at least one computer, cause the at least one computer to perform the steps of:
providing a CAD file specifying a two-dimensional photovoltaic module array layout;
specifying components of the two-dimensional photovoltaic module array layout, including a quantity of photovoltaic modules comprising the specified array, a quantity of inverters comprising the specified array, a quantity of MPPTs per inverter, a rated MPPT voltage; a rated MPPT amperage, a rated voltage of the photovoltaic modules at maximum power, a maximum DC input voltage of each of the quantity of inverters, a rated open circuit voltage of the photovoltaic modules, an expected operating temperature range, and a regional temperature constant;
converting the CAD file to a two-dimensional coordinate grid of cells, wherein each cell is assigned one of two values indicating either the presence or the absence of a photovoltaic module in accordance with the CAD file;
calculating and recording an ideal string length;
permuting the ideal string length at least once, and recording the at least one permuted ideal string length;
identifying hole cells in the specified array, and recording coordinates of the identified hole cells;
identifying edge cells in the specified array, and recording coordinates of the identified edge cells;
generating a string linearly or heuristically beginning from a recorded coordinate of an edge cell in accordance with the ideal string length and the at least one permuted ideal string length;
iterating the step of generating a string until all photovoltaic modules of the two-dimensional photovoltaic module array layout have been strung; and
passing a valid stringing solution to a CAD program, wherein the valid stringing solution strings all photovoltaic modules of the two-dimensional photovoltaic module array.

18. The process of claim 17, further comprising the step of counting a number of vertical stringing events comprising a valid stringing solution.

19. The process of claim 18, further comprising the step of recording the number of vertical stringing events as an optimal stringing solution if the stringing solution is the first generated stringing solution, or comparing the number of vertical stringing events to a previously recorded optimal stringing solution and overwriting the previously recorded optimal stringing solution if the number of vertical stringing events is fewer than the previously recorded optimal stringing solution.

20. The process of claim 19, wherein the valid stringing solution passed to the CAD program is an optimal stringing solution.

21. The process of claim 17, wherein the step of generating strings further comprises the steps of:
selecting a first set of recorded coordinates corresponding to an identified edge cell;
assigning a series value of one to the first set of selected coordinates;
applying a state transition function to select a second set of coordinates corresponding to a second cell from a set of cells neighboring the edge cell;
selecting the second set of coordinates corresponding to the second cell;
assigning a series value of two to the second set of coordinates;
applying a state transition function to select a next set of coordinates corresponding to a cell from a set of cells neighboring a current cell;
selecting the next set of coordinates corresponding to the next cell from; and
assigning a series value of n+1 to the next set of coordinates, wherein n is a series value of a next-previous set of coordinates corresponding to a next-previous cell.
